(19) United States
(12) Patent Application Publication
(10) Pub. No.: US 2011/0127847 A1
(43) Pub. Date: Jun. 2, 2011

(54) WIRELESS POWER SUPPLY DEVICE

(75) Inventors: Wei-Chih Shih, Taipei City (TW); Yen-Chih Chen, Taipei City (TW); Yi-Hsun Lin, Taipei City (TW)

(73) Assignee: COMPAL ELECTRONICS, INC., Taipei City (TW)

(21) Appl. No.: 12/953,467

(22) Filed: Nov. 24, 2010

Related U.S. Application Data
(60) Provisional application No. 61/265,336, filed on Nov. 30, 2009.

(51) Int. Cl. H02J 17/00

(52) U.S. Cl. 307/104

(57) ABSTRACT

A wireless power supply device adapted to wireless supply power to an electricity receiving object is provided. The wireless power supply device includes a transformer, a wireless power supply module, and an indicator. The wireless power supply module is coupled to the transformer to wirelessly supply electricity of the transformer to the electricity receiving object. The indicator is coupled to the wireless power supply module to display an operation state of the wireless power supply module.

### CROSS-REFERENCE TO RELATED APPLICATION

This application claims the priority benefit of U.S. provisional application Ser. No. 61/265,336, filed on Nov. 30, 2009. The entirety of the above-mentioned patent application is hereby incorporated by reference herein and made a part of this specification.

### BACKGROUND OF THE INVENTION

1. Field of the Invention

The present invention relates to a wireless power supply device.

2. Description of Related Art

Common electronic devices (for example, notebook computers) typically employ a power supply that connects with an alternating current power source to supply direct current power. In order to supply the direct current power to an electronic device, the power supply must connect with the electronic device via a cable, which causes inconvenience in use. It is believed to be a prospective solution to replace the power supply with a wireless power supply technology to supply power to the electronic device.

### SUMMARY OF THE INVENTION

The present invention is directed to a wireless power supply device which wirelessly supplies electricity to an electricity receiving object.

The present invention provides a wireless power supply device adapted to wirelessly supply electricity to an electricity receiving object. The wireless power supply device includes a transformer, a wireless power supply module, and an indicator. The wireless power supply module is coupled to the transformer to wirelessly supply electricity of the transformer to the electricity receiving object. The indicator is coupled to the wireless power supply module to display an operation state of the wireless power supply module.

In view of the foregoing, in the present invention, the indicator is coupled to the wireless power supply module and displays the operation state of the wireless power supply module.

In order to make the aforementioned and other features and advantages of the invention more comprehensible, embodiments accompanying figures are described in detail below.

### BRIEF DESCRIPTION OF THE DRAWINGS

FIG. 1 illustrates a wireless power supply device according to one embodiment of the present invention.

FIG. 2 illustrates a wireless power supply device according to another embodiment of the present invention.

FIG. 3A and FIG. 3B illustrate a wireless power supply device according to another embodiment of the present invention.

FIG. 4 illustrates a wireless power supply device according to another embodiment of the present invention.

FIG. 5 illustrates a wireless power supply device according to another embodiment of the present invention.

FIG. 6 illustrates a wireless power supply device according to still another embodiment of the present invention.

### DESCRIPTION OF THE EMBODIMENTS

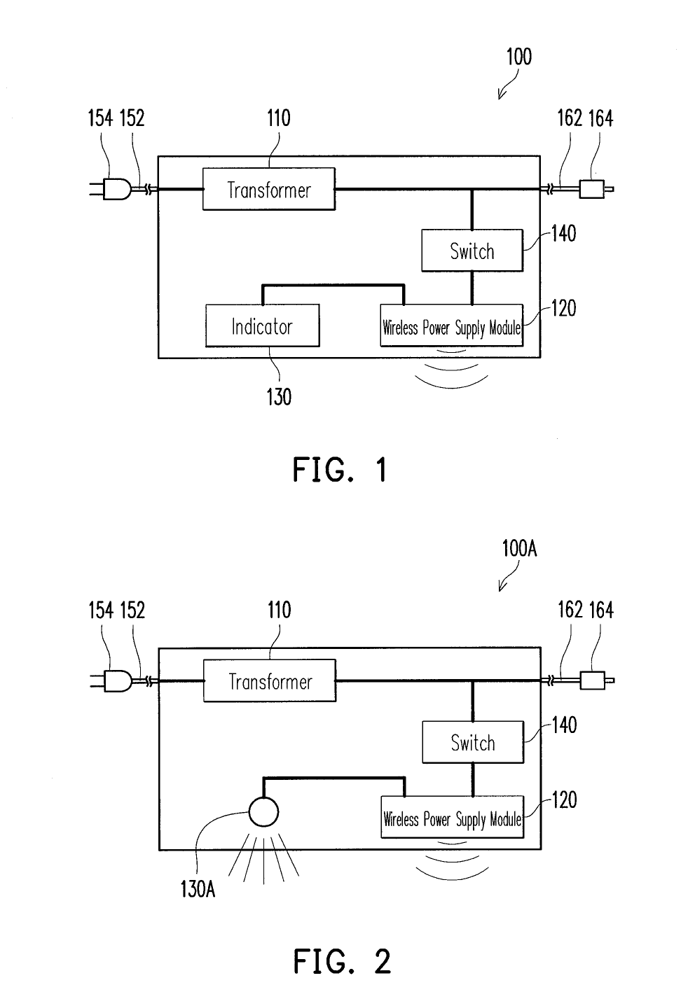

FIG. 1 illustrates a wireless power supply device according to one embodiment of the present invention. Referring to FIG. 1, the wireless power supply device 100 of the present embodiment is adapted to wirelessly supply electricity to an electricity receiving object, such as a notebook computer, a tablet PC, or a mobile phone. The wireless power supply device 100 includes a transformer 110, a wireless power supply module 120, and an indicator 130. The wireless power supply module 120 is coupled to the transformer 110 to wirelessly supply the electricity of the transformer 110 to the electricity receiving object. The indicator 130 is coupled to the wireless power supply module 120 to display the operation state of the wireless power supply module 120. The operation state of the wireless power supply module 120 may include whether the wireless power supply module 120 is operating, an electricity transmitting strength between the wireless power supply module 120 and the electricity receiving object, or an electricity transforming rate of the wireless power supply module 120. Therefore, a user may determine the operation state of the wireless power supply module 120 based on the displaying of the indicator 130.

In the present embodiment, the wireless power supply device further includes a switch 140. The switch 140 is coupled to the wireless power supply module 120 for activating or deactivating the wireless power supply module 120 upon receiving an external instruction. Therefore, a user may activate or deactivate the wireless power supply module 120 with this switch 140.

In the present embodiment, the wireless power supply device 100 may further include an input cable 152 and an input connector 154. One end of the input cable 152 is coupled to the transformer 110. The input connector 154 is connected with the other end of the input cable 152 and adapted to connect with an alternating current power source. Therefore, the transformer 110 may receive alternating current electricity via the input cable 152 and the input connector 154.

In the present embodiment, the wireless power supply device 100 may further include an output cable 162 and an output connector 164. One end of the output cable 162 is coupled to the transformer 110. The output connector 164 is connected with the other end of the output cable 164 and adapted to connect with an electricity receiving object. Therefore, the transformer 110 may supply direct current electricity via the output cable 162 and the output connector 164.

FIG. 2 illustrates a wireless power supply device according to another embodiment of the present invention. Referring to FIG. 2, the indicator of the wireless power supply device 110A is an indicating lamp 130A. Therefore, based on whether the indicating lamp 130A is emitting light or an emitting frequency of the indicating lamp 130A, the user can determine the operation state of the wireless power supply module 120, such as, whether the wireless power supply module 120 is operating.

In one embodiment, the user may determine whether the wireless power supply module 120 is normally operating based on whether the indicating lamp 130A is emitting light.

In another embodiment, the user may determine an electricity transmitting strength between the wireless power supply module 120 and the electricity receiving object based on the emitting frequency of the indicating lamp 130A.

In still another embodiment, the user may determine an electricity transforming rate of the wireless power supply module 120 based on the emitting frequency of the indicating lamp 130A. Specifically, when the wireless power supply module 120 continuously supplies electricity, the indicating lamp 130A intermittently emits light; when the electricity transforming rate of the wireless power supply module 120 is lower than a preset value, the indicating lamp 130A continuously emits light.

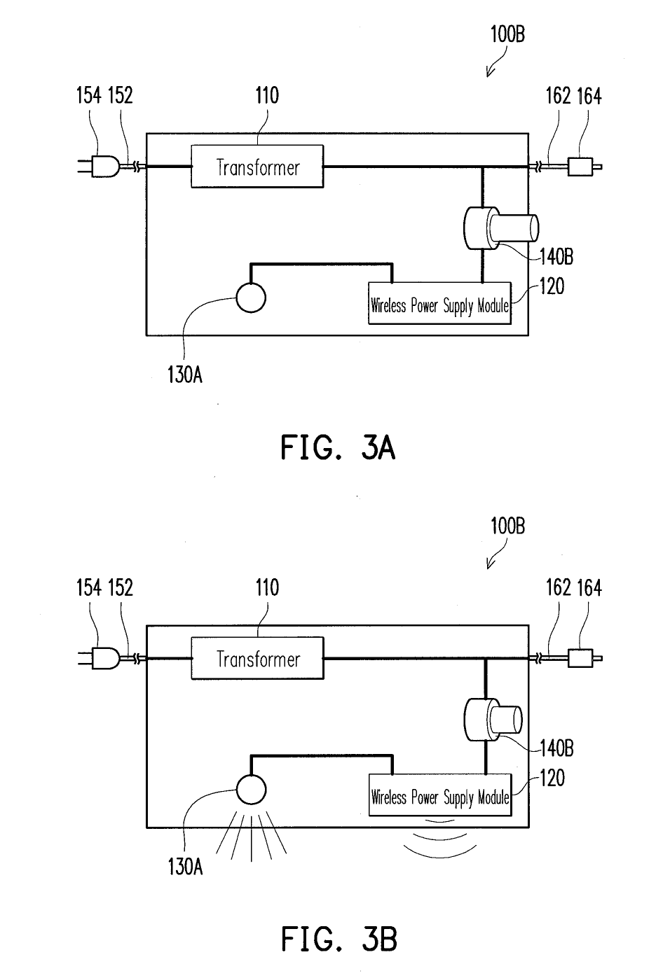

FIG. 3A and FIG. 3B illustrate a wireless power supply device according to another embodiment of the present invention. Referring to FIG. 3A, as compared with the embodiment of the FIG. 2, the switch of wireless power supply device 100B is a push switch 140B that can operate upon being pushed. Therefore, the user may push the push switch 140B to activate or deactivate the wireless power supply module 120.

Specifically, in FIG. 3A, the push switch 140B is not pushed such that the wireless power supply module 120 is deactivated and the indicating lamp 130A does not emit light. On the contrary, in FIG. 3B, the push switch 140B is pushed such that the wireless power supply module 120 is activated and the indicating lamp 130A emits light.

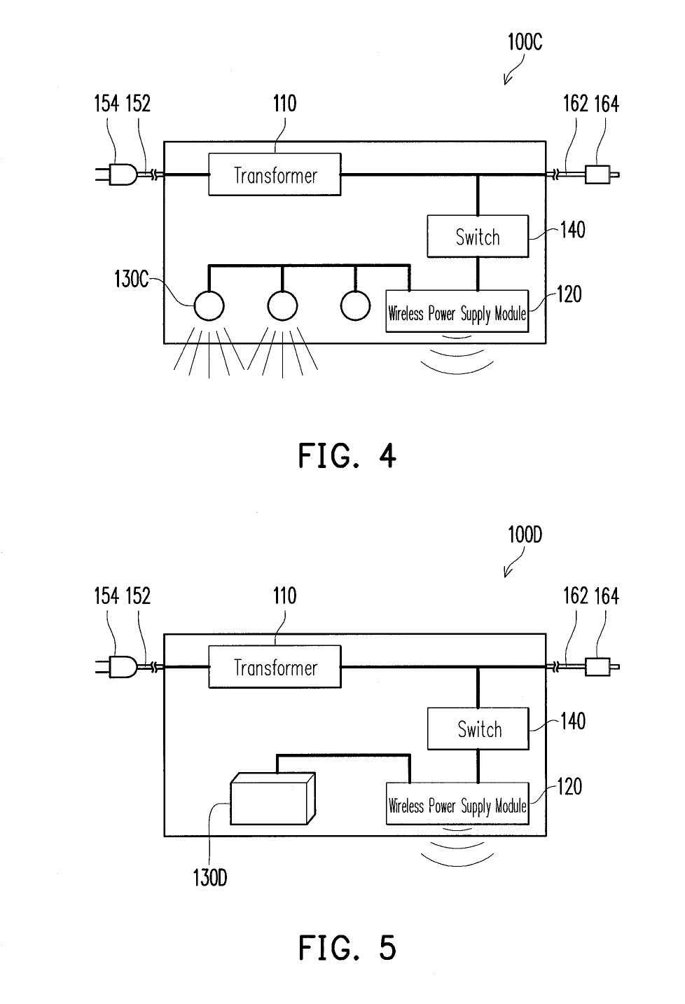

FIG. 4 illustrates a wireless power supply device according to another embodiment of the present invention. Referring to FIG. 4, the indicator of the wireless power supply device 100C of the present embodiment includes a plurality of indicating lamps 130C (three lamps are shown in FIG. 4). Therefore, based on whether the indicating lamps 130C are emitting light or the emitting frequency of the indicating lamps 130C, the user may determine the operation state of the wireless power supply module 120, such as, whether the wireless power supply module 120 is operating, the electricity transmitting strength between the wireless power supply module 120 and the electricity receiving object, or the electricity transforming rate of the wireless power supply module 120.

In one embodiment, the number of indicating lamps 130C to be emitting light among all the indicating lamps 130C can be determined based on the electricity transmitting strength between the wireless power supply module 120 and the electricity receiving object.

In another embodiment, the number of indicating lamps 130C to be emitting light among all the indicating lamps 130C can be determined based on the electricity transforming rate of the wireless power supply module 120.

FIG. 5 illustrates a wireless power supply device according to another embodiment of the present invention. Referring to FIG. 5, the indicator of the wireless power supply device 100D of the present embodiment is a character display 130D. Therefore, the user may determine the operation state of the wireless power supply module 120, such as, whether the wireless power supply module 120 is operating, the electricity transmitting strength between the wireless power supply module 120 and the electricity receiving object, or the electricity transforming rate of the wireless power supply module 120, based on the characters displayed on the character display 130D.

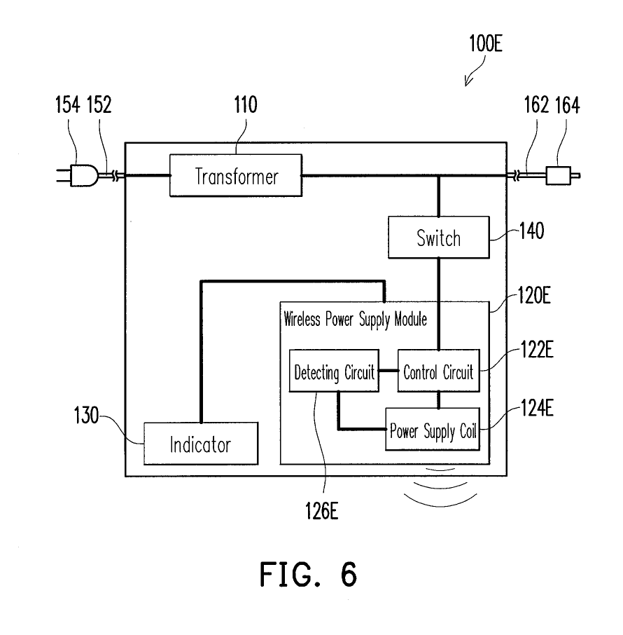

FIG. 6 illustrates a wireless power supply device according to still another embodiment of the present invention. Referring to FIG. 6, the wireless power supply module 120E of the wireless power supply device 100E of the present embodiment includes a control circuit 122E, a power supply coil 124E, and a detecting circuit 126E. The control circuit 122E is coupled to the indicator 130. The power supply coil 124E is coupled to the control circuit 122E to wirelessly supply electricity. The detecting circuit 126E is coupled to the control circuit 122E and the power supply coil 124E, to detect the operation state of the power supply coil 124E. The control circuit 122E causes the display 130 to display the operation state of the power supply coil 124E based on the detecting result of the detecting circuit 126E.

In summary, in embodiments of the present invention, the indicator is coupled to the wireless power supply module and displays the operation state of the wireless power supply module. Therefore, the user may determine the operation state of the wireless power supply module, such as, whether the wireless power supply module is operating, the electricity transmitting strength between the wireless power supply module and the electricity receiving object, or the electricity transforming rate of the wireless power supply module, based on the displaying of the indicator, thereby facilitating the use of the wireless power supply device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A wireless power supply device adapted to wirelessly supply electricity to an electricity receiving object, the wireless power supply device comprising:
a transformer;
a wireless power supply module coupled to the transformer to wirelessly supply electricity of the transformer to the electricity receiving object; and
an indicator coupled to the wireless power supply module to display an operation state of the wireless power supply module.

2. The wireless power supply device according to claim 1, further comprising:
a switch coupled to the wireless power supply module to activate or deactivate the wireless power supply module upon receiving an external instruction.

3. The wireless power supply device according to claim 1, wherein the indicator is an indicating lamp.

4. The wireless power supply device according to claim 1, wherein the indicator comprises a plurality of indicating lamps.

5. The wireless power supply device according to claim 1, wherein the indicator is a character display.

6. The wireless power supply device according to claim 1, wherein the wireless power supply module comprises:
a control circuit coupled to the indicator;
a power supply coil coupled to the control circuit to wirelessly supply electricity; and
a detecting circuit coupled to the control circuit and the power supply coil to detect the operation state of the power supply coil;
wherein the control circuit causes the indicator to display the operation state of the power supply coil based on the detecting result of the detecting circuit.

7. The wireless power supply device according to claim 1, further comprising:
an input cable, one end of the input cable coupled to the transformer; and
an input connector connected with the other end of the input cable and adapted to connect with an alternating current power source.

8. The wireless power supply device according to claim 1, further comprising:
an output cable, one end of the output cable coupled to the transformer; and
an output connector connected with the other end of the output cable and adapted to connect with another electricity receiving object.

9. The wireless power supply device according to claim 1, wherein the operation state of the wireless power supply module comprises an electricity transmitting strength between the wireless power supply module and the electricity receiving object.

10. The wireless power supply device according to claim 1, wherein the operation state of the wireless power supply module comprises an electricity transforming rate of the wireless power supply module.
